(19) United States
(12) Patent Application Publication
(10) Pub. No.: US 2007/0085983 A1
(43) Pub. Date: Apr. 19, 2007

(54) DIGITAL INK JET PRINTING PROCESS

(75) Inventors: VICTORY HUI-YANG KO, HSIN CHUANG (TW); CHIN-CHANG LEE, HSIN CHUANG (TW)

Correspondence Address: PHOTO MAN IMAGE CORPORATION, 4F-18, NO. 121, SEC. 1, CHONG QING SOUTH ROAD, TAIPEI, 100, TW

(73) Assignee: PHOTO MAN IMAGE CORPORATION, HSIN CHUANG (TW)

(21) Appl. No.: 11/163,361

(22) Filed: Oct. 17, 2005

(51) Int. Cl. G03B 29/00

(52) U.S. Cl. 355/28

(57) ABSTRACT

A digital ink jet printing process suitable for printing pictures and graphics is provided. The digital ink printing process comprises providing a substrate; performing a pre-process on the substrate to form a printing film; performing a printing process using a UV printer to print pictures and/or graphics on a surface of the printing film; and performing an after-process over the printed pictures of graphics to form a protective film over the printed pictures of graphics.

### FIELD OF THE INVENTION

This invention relates generally to a digital ink jet printing process, and more particularly, to a digital ink jet printing process, including a pre-process and an after process, for printing high quality pictures and graphics on the surface of inorganic, organic and metal substrates with high durability.

### DESCRIPTION OF RELATED ART

Heretofore, among the building materials, ceramic tiles are most common building material. Generally, ceramic tiles are of two types: single color without graphics and multiple ceramic tiles with different colors that can be laid out together to form a single or multiple patterns.

In conventional process of manufacturing multicolored ceramic tiles, first, the designers define the size, fill the tiles with glaze for desired color and then subject the tiles to a high thermal treatment. The kiln can produce desired colors and patterns, however the color variety is limited and cannot produce full color pattern.

In the modern society, in order to impress consumers with new products or enterprise's image, besides the use of traditional signs and boards, a new method is to print a huge picture for displaying over an exterior surface of a structure, such as a building, automobile such as bus and train. If the pattern is a color picture or painting, the prior art technology cannot print the full color pattern on the surface of the ceramic tiles suitable for adhering to the exterior of a building, or suitable material for adhering on the body of an automobile.

Current printer technology is capable of producing excellent full color images; however they are limited to print only on the surface of the paper. More advanced printer can print on soft materials with special inks. Furthermore, an ink-jet printer (Uvjet215-C) manufactured by a Swiss company uses UV curable inks, which dries upon exposure to ultraviolet light, can print directly on the surface of any materials. However, because of the poor adhesion of inks on ceramic tiles or metal, the printed graphic may be easily damaged or peel off when touched or other external factors.

### SUMMARY OF THE INVENTION

It is therefore a primary object of the invention to provide a low cost digital ink jet printing process with high speed printing efficiency.

It is still an object for the invention to provide a digital ink jet printing process for printing picture or graphics directly on the surface of the substrates.

It is still another object for the invention to provide a digital full color printing process.

In accordance with the above objectives of the present invention, a digital ink jet printing process is provided. The digital ink printing process comprises providing a substrate; performing a pre-process on the substrate to form a printing film; performing a printing process using a UV printer to print pictures and/or graphics on a surface of the printing film; and performing an after-process over the printed pictures of graphics to form a protective film over the printed pictures of graphics.

According to an aspect of the present invention, a variety graphics may be printed on a variety of substrate without any type of color limitation and the printed graphics can be scratch-proof and water-proof, and therefore more durable and of comparatively high quality.

### BRIEF DESCRIPTION OF THE DRAWINGS

For a more complete understanding of the present invention, reference will now be made to the following detailed description of preferred embodiments taken in conjunction with the accompanying drawings as follows.

FIG. 1 is a flow chart of a digital ink jet printing process according to an embodiment of the present invention.

FIG. 2 is a flow chart a digital ink jet printing process according to another embodiment of the present invention.

FIG. 3 is a graphic printed on exterior walls of buildings according to an embodiment of the present invention.

### DETAIL DESCRIPTION OF THE INVENTION

For illustrating various embodiments of the present invention, the substrates described herein are generally inorganic and organic type of substrates including ceramic, plastic such as glass, poly vinyl chloride (PVC), polycarbonate (PC) and acrylic resin, metal such as aluminum, and the like.

A digital ink jet printing process suitable for printing pictures and graphics is provided. The digital ink printing process comprises providing a substrate; performing a pre-process on the substrate to form a printing film; performing a printing process using a UV printer to print pictures and/or graphics on a surface of the printing film; and performing an after-process over the printed pictures of graphics to form a protective film over the printed pictures of graphics.

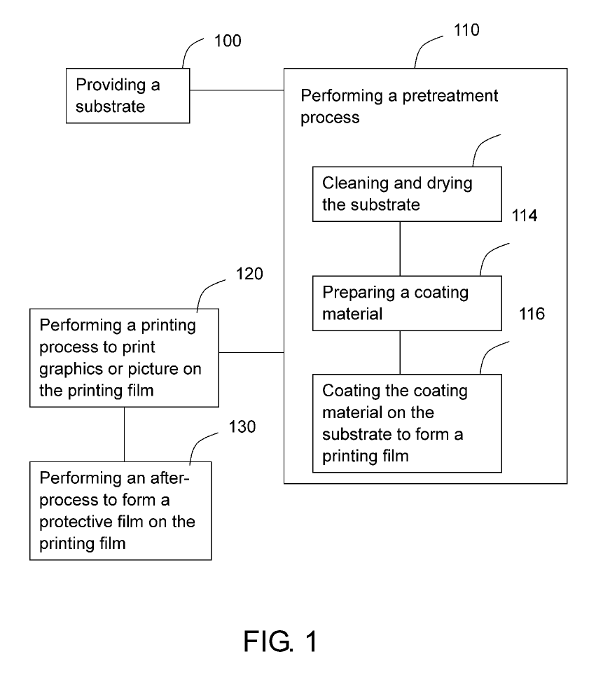

Referring to FIG. 1, to implement the digital ink jet printing process on an inorganic substrate, ceramic tiles for example, first, the pre-treatment process is performed on the ceramic tiles. The digital printing process according to this embodiment comprises the following steps.

At step 100, a substrate is provided.

At step 110, a pretreatment process is performed to form a printing film on the substrate. The pretreatment process comprises the sub steps of cleaning and drying the substrate (step 114), preparing a coating material (step 114) and then coating the coating material on the substrate to form the printing film (116).

At step 120, a printing process is performed using a UV printer to print graphics or pictures on the printing film.

At step 130, a protective film is formed on the printing film to protect the printed graphics or pictures on the printing film.

Hereinafter the pretreatment process is described. First, the ceramic tiles are cleaned and dried. Next, a coating material is prepared and the coating material is subjected to a baking step. During the baking step, the coating material is heated at 80° C. for 20 minutes. Next, the coating material cooled. Then, the coating material is coated on the ceramic tiles to form a printing film thereon, wherein the thickness of the printing film is, for example but not limited to, 10˜40 μm. The coating material comprises, for example but not limited to, neopentyl(diallyl)oxy, tri(dioctyl)pyro-phosphatotitanate, cyclo(dineopentyl(diallyl))pyrophosphato dineopentyl(diallyl)zirconate, neopentyl(diallyl)oxy, zirconate, gamma-aminopropy-ltriethoxysilan, 3-methacryloxypropyltrimethoxysilane, Glycidoxypropyl trimethoxysilane or Hydrolyzed aminoethylaminopropylsilane. Next, the printing film is allowed to stand by for 10 minutes, then baked at 160° C. for 20 minutes and then cooled down. Next, a surface roughening process is performed on the printing film using sand papers or sand to obtain a coarse surface. Next, the coarse ceramic tiles are cleaned and dried.

The pre-treatment process described above may increase the adhesion between the substrate and the graphics. The printing film described above comprises, for example but not limited, to a thermal curable resin, such as phenol resin, alcohol acid resin, polyester resin, amino formic acid ester resin, vinyl resin, propylene acid resin or silicon resin with mineral. The thermal curable resin may provide scratch-proof feature. The coarse surface obtained by the surface roughening may also increase the adhesion surface area on the ceramic tiles.

The printing process is performed on the surface of the pre-treated surface of the ceramic tiles using a UV printer to print graphics thereon. The UV printer uses UV curable ink which quickly dries upon exposure to ultraviolet light. The graphics and/or the pictures may be directly printed on the surface of the coarse ceramic tiles using the UV curable ink via the UV printer.

To protect the graphics printed on the surface of the pretreated surface of the ceramic tiles and enhance the scratch-proof and weather fastness features, the aforementioned after-process is performed. The after-process includes spray coating a protective film, with a thickness of, for example but not limited to, 10˜40 μm. Thereafter, the protective film is allowed to stand by for 10 minutes. Next, the protective film is subjected to a baking step where the protective film is treated at 160° C. for 20 minutes and thereafter, the ceramic tiles is cooled down.

The protective film described above may comprise, for example but not limited to, propylene acid resin or propylene acid of styrene epoxy resin complex, or PTFE solution type paint or PVDF/PMMA solution type paint, PVDF/PMMA water-soluble paint or fluorescent ink.

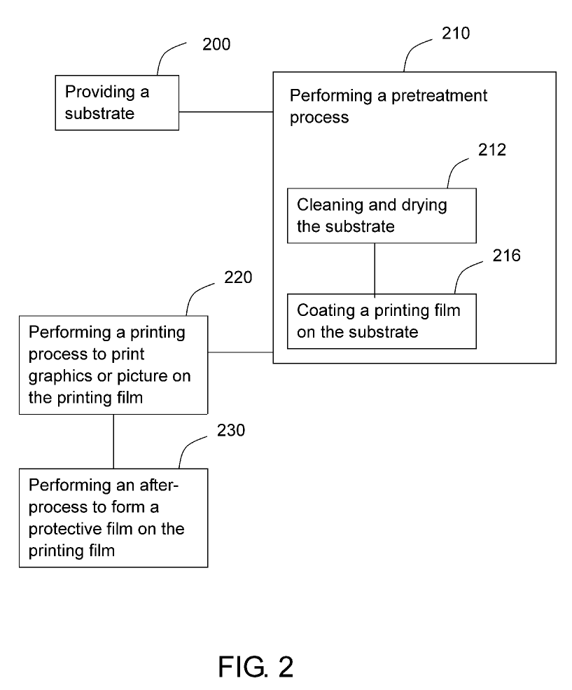

Hereinafter, a digital ink jet printing process according to another embodiment of the present invention is described with reference to FIG. 2 as follows. Referring to FIG. 2, to implement the digital ink jet printing process on a metallic substrate, aluminum board for example, first, the pre-treatment process is performed on the surface of the aluminum board. The digital printing process according to this embodiment comprises the following steps.

At step 200, a substrate is provided.

At step 210, a pretreatment process is performed to form a printing film on the substrate. The pretreatment process comprises the sub steps of cleaning and drying the substrate (step 214), and then coating printing film on the substrate (216).

At step 220, a printing process is performed using a UV printer to print graphics or pictures on the printing film.

At step 230, a protective film is formed on the printing film to protect the printed graphics or pictures on the printing film.

The pre-treatment process includes first cleaning and drying the aluminum board. Next, a printing film is spray coated on the surface of the aluminum board and then dried. Next, the printing film is subjected to a baking step where the printing film is baked at 80° C. for 20 minutes. Next, the printing film is cooled. The thickness of the printing film is, for example but not limited to, 25˜50 μm. Next, the printing film is allowed to stand by for 10 minutes. Next, a surface roughening process using sand paper or sand is carried out on the printing film to obtain a coarse aluminum board. Next, the coarse aluminum board is cleaned and dried.

The printing film described above comprises, for example but not limited to a thermal curable resin, such as phenol resin, alcohol acid resin, polyester resin, amino formic acid ester resin, vinyl resin, propylene acid resin or silicon resin with mineral.

The pre-treatment process described above may increase the adhesion between the substrate and the graphics. The thermal curable resin may provide scratch-proof feature. The coarse surface obtained by the surface roughening may also increase the adhesion surface area on the aluminum board.

The printing process is performed on the surface of the coarse aluminum board using a UV printer to print graphics thereon. The UV printer uses UV curable ink which quickly dries upon exposure to ultraviolet light. The UV curable ink via the UV printer can be directly printed on the surface of any material.

To protect the graphics printed on the surface of the pretreated surface of the aluminum board and enhance the scratch-proof and weather fastness features, the aforementioned after-process is performed. The after-process includes spray coating a protective film, with a thickness of, for example but not limited to, 10˜40 μm. The protective film comprises, for example but not limited to, propylene acid resin or propylene acid of styrene epoxy resin complex, or PTFE solution type paint or PVDF/PMMA solution type paint, PVDF/PMMA water-soluble paint or fluorescent ink. Thereafter, the aluminum board is allowed to stand by for 10 minutes. Next, the aluminum board is subjected to a baking step where the aluminum board is treated at 70° C. for 20 minutes and thereafter, the aluminum board is cooled down.

Following are the test results of the printing process of the present invention:

1. Ink and protective coating cross-cut test ASTM D 3002 D 3359: class: 5B.

2. Protective coating Pencil Hardness test ASTM D 3363-3H.

3. Protective coating wear-proof test CNS 10784: wear amount under 0.01 g.

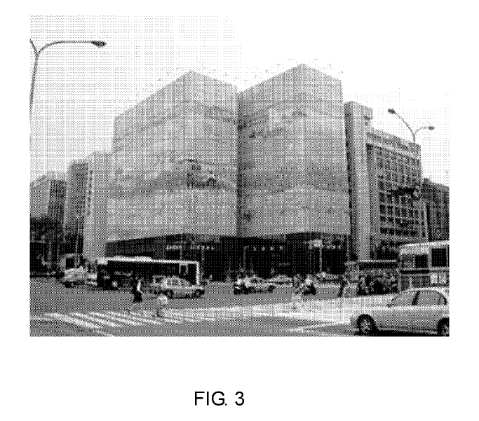

The present invention may be applied for printing graphics and or pictures directly on interior and exterior walls of buildings, as shown in FIG. 3. Graphics and or pictures may also be printed on PVC boards or ceramic tiles or aluminum boards. The ceramic tiles printed with graphics and or pictures may be then adhered to the interior and exterior walls of buildings for decoration. The PVC boards printed with graphics and or pictures may be adhered to the body of automobiles, such as bus, train, car and the like, for advertisements. Art creation may also be likewise printed on the interior or exterior walls of the buildings not only for displaying the art creation but also makes the artist famous and beautifies the city and also serves as the unique landmark of the city.

Accordingly, the digital inkjet printing process of the present invention has at least the following advantages.

As described above, the graphics may be directly printed on any materials and therefore, the present invention provides a broadest range of choice of substrate materials for selection according to any requirements.

As special plate is not required for preparing graphic patterns as in the case of the prior art, pictures and graphics may be printed on any substrates without the limitation of the type of colors. Thus, not only the overall quality of the pictures and graphics is substantially increased but also substantially increases the printing speed and thereby increase the throughput.

The pre-process and after process of the present invention described above is capable of effectively promoting the durability of the printed pictures and/or graphics and better resist the external environmental factors.

While a preferred embodiment of the invention has been shown and described in detail, it will be readily understood and appreciated that numerous omissions, changes and additions may be made without departing from the spirit and scope of the present invention.

What is claimed is:

1. A digital ink jet printing process suitable for printing pictures and graphics, comprising:
providing a substrate;
performing a pre-process on the substrate to form a printing film;
performing a printing process using a UV printer to print pictures and/or graphics on a surface of the printing film; and
performing an after-process over the printed pictures of graphics to form a protective film over the printed pictures of graphics.

2. The digital ink jet printing process suitable for printing pictures and graphics as claimed in claim 1, wherein the pre-process comprises:
cleaning the substrate;
drying the cleaned substrate;
preparing a coating material;
heating the coating material;
cooling the coating material;
coating the substrate using the coating material to form a printing film over the base film;
allowing the printing film to stand by;
baking the printing film; and
cooling the printing film.

3. The digital ink jet printing process suitable for printing pictures and graphics as claimed in claim 2, wherein the pre-process further comprises:
performing a surface treatment process on the printing film;
cleaning the surface treated printing film; and
drying the surface treated printing film.

4. The digital ink jet printing process suitable for printing pictures and graphics as claimed in claim 3, wherein the surface treatment process is accomplished by using sand papers.

5. The digital ink jet printing process suitable for printing pictures and graphics as claimed in claim 3, wherein the surface treatment process is accomplished by using sand.

6. The digital ink jet printing process suitable for printing pictures and graphics as claimed in claim 1, wherein the after-process comprises:
spray coating a protective film over the printed pictures of graphics;
allowing the protective film to stand by;
performing a thermal treatment on the protective film; and
cooling the protective film.

7. The digital ink jet printing process suitable for printing pictures and graphics as claimed in claim 2, wherein the coating material comprises Neopentyl(diallyl)oxy, tri(dioctyl)pyro-phosphatotitanate, cyclo(dineopentyl(diallyl))pyrophosphato dineopentyl(diallyl)zirconate, neopentyl(diallyl)oxy, zirconate, gamma-aminopropy-ltriethoxysilan, 3-methacryloxypropyltrimethoxysilane, Glycidoxypropyl trimethoxysilane or Hydrolyzed aminoethylaminopropylsilane.

8. The digital ink jet printing process method recited in claim 2, wherein the coating material is heated to a temperature of 70° C.˜90° C. for 20˜30 minutes and allowed to stand by at a stable temperature for more than an hour.

9. The digital ink jet printing process suitable for printing pictures and graphics as claimed in claim 2, wherein the printing film comprises thermal curable resin, phenol resin, alcohol acid resin, polyester resin, amino formic acid ester resin, vinyl resin, propylene acid resin or silicon resin.

10. The digital ink jet printing process suitable for printing pictures and graphics as claimed in claim 1, wherein a thickness of the printing film is 10˜40 μm.

11. The digital ink jet printing process suitable for printing pictures and graphics as claimed in claim 1, wherein the printing film is heated to a temperature of 50° C.˜160° C. for 20˜60 minutes.

12. The digital ink jet printing process suitable for printing pictures and graphics as claimed in claim 1, wherein the protective film comprises propylene acid resin or propylene acid of styrene epoxy resin complex, or PTFE solution type paint or PVDF/PMMA solution type paint, PVDF/PMMA water-soluble paint or fluorescent ink.

13. The digital ink jet printing process suitable for printing pictures and graphics as claimed in claim 1, wherein a thickness of the protective coating is 10˜40μ.

14. The digital ink jet printing process suitable for printing pictures and graphics as claimed in claim 1, wherein the protective film is heated to a temperature of 50° C.˜160° C. for 20˜60 minutes.

15. The digital inkjet printing process suitable for printing pictures and graphics as claimed in claim 1, wherein the substrate comprises plastic board or metallic board.

16. The digital ink jet printing process suitable for printing pictures and graphics as claimed in claim 1, wherein the substrate comprises plastic board comprises ceramic tiles.

17. The digital ink jet printing process suitable for printing pictures and graphics as claimed in claim 1, wherein the substrate comprises plastic board comprises glass, poly vinyl chloride (PVC), polycarbonate (PC), acrylic resin.

18. The digital ink jet printing process suitable for printing pictures and graphics as claimed in claim 1, wherein the substrate comprises plastic board comprises aluminum.
